(19) United States
(12) Patent Application Publication
(10) Pub. No.: US 2023/0140964 A1
(43) Pub. Date: May 11, 2023

(54) PLANT-BASED PRODUCT

(71) Applicant: AGENCY FOR SCIENCE, TECHNOLOGY AND RESEARCH, Singapore (SG)

(72) Inventors: Hanry Yu, Singapore (SG); Shujian Ong, Singapore (SG)

(21) Appl. No.: 17/801,582

(22) PCT Filed: Jul. 27, 2020
(86) PCT No.: PCT/SG2020/050432

§ 371 Date: Aug. 23, 2022

(30) Foreign Application Priority Data
Feb. 28, 2020 (SG) 10202001803R

(51) Int. Cl. A23J 3/14; A23L 5/40; A23J 3/22

(52) U.S. Cl. CPC A23J 3/14; A23L 5/40; A23J 3/227

(57) ABSTRACT

The invention relates to treating a plant-based material with an agent and/or a force to enable the plant-based material to mimic the colour of animal products, wherein the agent and/or force is capable of controlled permeabilisation of cell membrane to thereby release polyphenols from the cells of the plant-based material to allow polyphenol-cell wall interaction and/or causes the oxidation of polyphenols in the plant-based material. Also disclosed is a plant-based food product, such as plant-based meat substitutes, produced by the process thereof.

### TECHNICAL FIELD

The present invention relates to processes or methods of preparing plant products to have an appearance similar to an animal product.

### BACKGROUND

The world would need to feed and produce twice as much protein by 2050. While meat is a common source of protein, conventional meat production methods are unsustainable. There is an urgent need for alternative protein sources to feed the people of tomorrow.

Alternative proteins represent a broad category of products that echo the movement towards reduced animal dependence for food. Examples include plant-based proteins, mycoprotein, insect proteins and cell-based meat. In recent times, a new wave of meat analogues has emerged, with an emphasis on creating a convincingly meaty taste, texture, and appearance. It has been found that the acceptance of meat substitutes has been attributed mainly to its appearance. Efforts have been made to impart a “bloody” colour to meat substitutes, using plant-derived colouring such as red beet juice and soy leghaemoglobin. The problem with these additives is the leaching of colourings due to the water-soluble nature of these additives. Inclusion of additives will add to the ingredient list, giving consumers the impression of a heavily processed product, which is unappealing. It is desirable to minimise use of additives and shorten ingredient lists to appeal to consumers. Thus, there is a need to provide an alternative method of producing plant-based animal products. In particular, a method of producing plant-based products that have the appearance of animal products.

### SUMMARY

In one aspect, there is provided a process, comprising treating a plant-based material with an agent and/or a force capable of permeabilising cell membrane and/or oxidising polyphenols, wherein the agent and/or force is capable of controlled permeabilization of cell membrane to thereby release polyphenols from the cells of the plant-based material to allow polyphenol-cell wall interaction and/or causes the oxidation of polyphenols in the plant-based material.

In various embodiments, the agent causes loss of sub-cellular compartmentalisation of polyphenols and cellulose cell wall

In various embodiments, the agent and/or the force capable of controlled permeabilization of cell membrane and/or oxidising polyphenols causes oxidation of phenols to o-quinones and/or polymerisation to form coloured pigments.

In various embodiments, the agent is selected from the group consisting of a detergent, a redox agent, an enzyme, and an extract of a plant-based material.

In various embodiments, the agent and/or force maintains the cellulosic structures of the plant-based materials.

In various embodiments, the force is homogenisation and/or mechanical and physical shearing. In various embodiments, the plant-based material comprises polyphenols and/or polyphenol oxidases.

In various embodiments, the plant-based material comprises polyphenols from about 10 mg GAE (gallic acid equivalence) per 100 g dry weight of polyphenol or more.

In various embodiments, wherein the plant-based material comprises a parenchyma tissue and/or a sclerenchyma tissue.

In various embodiments, the plant-based material is selected from the group consisting of apricots, avocados, banana, belimbi, binjai, cherries, Chinese pear, ciku, cucumber, custard apple, date, dragon fruit, duku, figs, golden kiwi, grape, grapefruit, guava, hog plum, honey dew, jackfruit, kiwifruit, kuini, langsat, lemons, lime, longan, loquat, lychee, mandarin orange, mango, mangosteen, mata kuching, mulberry, nectarine, nutmeg, orange, papaya, passion fruit, peach, pear, persimmon, pineapple, plum, pomegranate, pomelo, pulasan, quince, rambai, rambutan, raspberry, raspberry, rhubarb, rock melon, salak, soursop, starfruit, strawberry, tamarillo, tamarind, tomato, water apple, watermelon, wax jambu, aloe vera, asparagus, baby corn, banana flower, bean sprouts, broccoli, brussels sprouts, carrot, cauliflower, celery, champignon, chilli, choko, cucumber, drumstick vegetable, eggplant, fungus, gourd, Jew's ear, leek, lily bud, loofah, mushroom, okra, olive, papaya shoots, pea shoot, peppers, pumpkin, sea moss, seaweed, soybean sprouts, sweetcorn, tomato, white fungus, zucchini, bamboo shoots, beetroot, breadfruit, carrot, corn, garlic, ginger, huai shan, lengkuas, lotus root, onion, potato, radish, sweet potato, tapioca, taro, turnip, water chestnut, yam, white cabbage, chrysanthemum, endives, leek, lettuce, mustard cabbage, nai bai, sweet potato shoots, tapioca shoots, wintermelon, yam stalk, beans, chickpeas, long beans, peas, petai, and snow peas.

In various embodiments, the plant-based material comprises minimal to no chlorophyll.

In various embodiments, the process is free of colouring agents.

In various embodiments, the plant-based material is treated with the agent for about 1 hour to about 10 days, optionally the plant-based material is treated with the agent for one day or more, or two days or more, or three days or more, or 4 days or more, or 5 days or more, or 6 days or more, or 7 days or more, or 8 days or more, or 9 days or more, or 10 days. In various embodiments, the plant-based material is treated with the force for about 1 minute to about 1 day, optionally the plant-based material is treated with the force for 1 mins or more, or 5 mins or more, or 10 mins or more, or 20 mins or more, or 30 mins or more, or 1 hour or more, or 2 hours or more, or 3 hours or more, or 4 hours or more, or 5 hours or more, or 6 hours or more, or 7 hours or more, or 8 hours or more, or 9 hours or more, or 10 hours or more, or 11 hours or more, or 12 hours or more, or 13 hours or more, or 14 hours or more, or 15 hours or more, or 16 hours or more, or 17 hours or more, or 18 hours or more, or 19 hours or more, or 20 hours or more, or 21 hours or more, or 22 hours or more, or 23 hours or more, or one day.

In various embodiments, a part of the plant-based material is treated with the agent at differential concentration and/or time.

In another aspect, there is provided a plant-based product comprising: a composition comprising a plant-based material processed as disclosed herein.

In various embodiments, the plant-based product further comprising one or more different plant-based material, optionally the plant-based material comprises a parenchyma tissue and/or a sclerenchyma tissue of the plant-based material.

### BRIEF DESCRIPTION OF THE DRAWINGS

Exemplary embodiments of the invention will be better understood and readily apparent to one of ordinary skill in the art from the following written description, by way of example only, and in conjunction with the drawings, in which:

FIG. 1 shows colour change of jackfruit when treated with various reagents (% w/v) for 5 days. (A) Representative image of jackfruit sample after treatment; (B) Quantified colour change in CIELAB colour space (a colour space defined by the International Commission on Illumination (CIE) in 1976).

FIG. 2 shows colour change of minced jackfruit washed with deionized water (PVP−) and polyvinylpyrrolidone (PVP+).

FIG. 3 shows colour change of jackfruit when treated with sodium dodecyl sulfate (SDS). (A) Quantified colour change in CIELAB colour space; (B) Average colour of each sample.

FIG. 4 shows colour stability of processed jackfruit in different conditions over time. (A) Processed jackfruits stored in different media conditions with time; (B) Quantified CIELAB colour score of each jackfruit sample across time.

FIG. 5 shows processed jackfruits cooked over time. (A) Jackfruits cooked in tap water; (B) Jackfruits cooked in sunflower oil.

FIG. 6 shows patterned meat mimicry with plant-based materials. High resolution image of cooked (left) and uncooked (right) pork belly-like construct formed with processed jackfruits and water chestnut. Scale bar represent 1 cm.

FIG. 7 shows comparison of colour between various types of meats and processed jackfruits. (From top to bottom) Comparison between chicken and jackfruit treated with 5% jackfruit extract. Comparison between pork and jackfruit treated with 10% jackfruit extract. Comparison between beef and jackfruit treated with 100% jackfruit extract.

FIG. 8 shows colour control of persimmon with jackfruit extract. (A) Persimmon before and after treatment with jackfruit extracts. (B) Close-up image of lined patterns. Scale bar represents 500 μm.

FIG. 9 shows colour control of starfruit with jackfruit extract. (A) Starfruit before and after treatment with jackfruit extracts. (B) Close-up image of lined patterns. Scale bar represents 500 μm.

FIG. 10 shows differential colour control of jackfruit to create intricate patterns to mimic meat marbling. (A) Uncooked jackfruit treated to create marbling patterns. (B) Cooked marbled jackfruit. (C) Comparison of uncooked marbled jackfruit (left) with a piece of cured pork (right). (D) Comparison of fried marbled jackfruit (left) with a piece of fried cured pork (right).

FIG. 11 shows colour change of jackfruits over time due to oxidation.

FIG. 12 shows time-lapse imaging of development of marbling patterns in jackfruit.

FIG. 13 shows comparison of colour between coloured (i.e. controlled colouring based on the process/method as described herein) and naturally oxidized jackfruit.

### DETAILED DESCRIPTION

Meat alternatives such as plant-based meat substitutes and cell-based meats have gained attention in recent years as more sustainable protein sources. It is important to control the appearance (such as colour and texture) of the meat substitutes which contributes significantly to the palatability of the food product. Natural plant materials can be a cheap and scalable alternative to meats, but often lack the colour and appearance of meat. Most high-protein plants used in meat substitutes, such as soy, lack a meat-like colouration. Known attempts to control the colour of meat substitutes involves addition of water-soluble food colouring. However, such attempts do not confer natural appearance and can be washed out or changed during cooking and processing.

Thus, the inventors of the present disclosure have found an alternative method of producing plant-based food product that has the appearance of an animal product. Disclosed herein is a method of processing or a process of producing a plant-based food product having the appearance of an animal-based product.

Polyphenols are naturally occurring phytochemicals that occur in a wide range of medicinal and dietary plants. Polyphenols are known to be involved in enzymatic browning of minimally processed fruits and vegetables. Loss of sub-cellular compartmentalization of polyphenols and polyphenol oxidases (PPO) leads to oxidation of phenols to o-quinones and eventual polymerization to form brown pigments. To mitigate such undesirable discolouration or browning, storage in acidic pH to denature PPO or addition of antioxidants to prevent oxidation are typically practiced.

Interactions between polyphenols and polysaccharides have been studied extensively and are typically associated with reduced polyphenol extractability and bioavailability in fruits and vegetables. Upon mechanical shearing, disruption of cell membranes allows adsorption of polyphenols to plant cell walls via hydrogen bonding and hydrophobic interacts with cellulose and pectin. Such interactions are usually seen as undesirable as it reduces free polyphenols in plant juice and bound polyphenols would be less easily absorbed by the body, reducing health benefits. These studies are not associated with colour changes.

While the above-mentioned phenomenon has been widely seen as undesirable, the present inventors seek to exploit such mechanism to obtain desired colours. As such, disclosed herein is a method for controlling the colour of plant materials to permanently mimic the colour of animal products (such as meat, fat, and the like). The inventors of the present disclosure found that by controlling the disruption of cellular compartmentalization, extended interactions between intracellular polyphenols and extracellular plant cell wall will allow development of animal-based product-like colouration (for example meat-like colouration). Release of intracellular contents can be mediated by colourless chemical permeabilizing agents or mechanical homogenization. It is found that the method of the present disclosure surprisingly would not require addition of food colouring and the colour would not leach into water or oil during cooking.

Thus, there is provided a process/method of preparing a plant-based material to have an appearance of an animal-based product. The method comprises treating a plant-based material with an agent and/or a force capable of permeabilising cell membrane and/or oxidising polyphenols.

As used herein, the phrase “plant-based material” refers to a material or article that is obtained from or is a part of a plant or part or fragment thereof. The material may be any parts or fragment of the plant, including but is not limited to, a root, a stem, a branch, a leave, a flowering part, a fruit, a seed, and combinations or combinations of parts thereof. In various embodiments, the plant-based material comprises polyphenols. In various embodiments, the plant-based material may be a fruit. In various embodiments, the plant-based material is a fruit comprising polyphenols. In various embodiments, the plant-based material may comprise parts of plant that comprises (uniform) parenchyma (i.e. the “plant flesh”). In various embodiments, the plant-based material may comprise sclerenchyma tissue (or “plant veins”). In various embodiments, the plant-based material comprises a parenchyma tissue and/or a sclerenchyma tissue. Without wishing to be bound by theory, as the sclerenchyma tissue may not be coloured by the colouring technique described herein, such sclerenchyma tissue would create a marble-like pattern where the plant-based parenchyma tissue (the “plant flesh”) would constitute the meaty-red part of an animal-based product (such as meat) and white sclerenchyma tissue would constitute the veins, fat, or white parts of a meat. The presence of plant-based material parenchyma tissue and sclerenchyma tissue in one material could advantageously allow for a one-step staining (using one protocol and/or one treatment) that creates differential patterns of meat (for example brown/red) in the parenchyma tissue and other parts of an animal product (such as veins, fat, or other white parts of a marbled meat) in the sclerenchyma tissue of the plant materials to thereby mimic meat marbling. This is in contrast to techniques currently known in the art where marbled pattern in a plant-based material may be achieved by separately providing homogenous colour controls or blending separate coloured materials together. Thus, in some examples, the present disclosure also provides a process/method of modifying the appearance of a plant-based material that comprises both sclerenchyma tissue and parenchyma tissue by releasing polyphenols from the cells of the plant-based materials using cell permeabilizing agents or physical homogenisation. In some examples, the plant-based materials may be incubated with the permeabilising agents and/or subjected to the force for a duration of time without the addition of colouring agents, where the presence of sclerenchyma and parenchyma tissues in the plant-based material is envisaged to provide differentially coloured product with intricate patterns that mimic animal-based product (such as meat marbling).

As used herein, the phrase “animal-based product” refers to a material or article that have been obtained or is part of an animal. An animal-based product may include, but is not limited to, meat (or musculature), fat, tendon, offal, and combinations or combinations of parts thereof. In various embodiments, the animal-based products may include fresh and/or processed animal-based products. In various embodiments, the animal-based product may include fresh animal product such as meat, fat, tendon, and offal. In various embodiments, the animal-based product may include processed animal-based products such as cured animal-based products, animal-based smoked, animal-based salted, and animal-based emulsion. In various embodiments, the animal-based products may include fresh meats, fresh fat, fresh tendon, fresh offal, and combinations thereof, and the like. In various embodiments, the animal-based products may include processed meats such as cured, smoked, salted meats, meat emulsions and the like.

The present inventors have surprisingly found that controlled disruption of cellular compartments (i.e. controlled decompartmentalization) allows for extended interactions between intracellular polyphenols and extracellular plant cell walls, which are the important elements in the control of colour changes in plant materials. The inventors have found that such colour changes surprisingly lead to permanent mimicking of an animal-based product (such as meat) appearance in a plant-based material without food colour additives. Indeed, when intracellular polyphenols were released by chemical permeabilization or mechanical homogenization, further incubation for extended periods of time intensifies the animal-based material-like colouration (e.g. meat-like colouration). As such, in one aspect, there is provided a process, comprising treating a plant-based material with an agent and/or a force capable of permeabilising cell membrane and/or oxidising phenols (such as polyphenols).

In some embodiments, the agent and/or force is capable of controlled permeabilization of cell membrane to thereby release polyphenols from the cells of the plant-based material to allow polyphenol-cell wall interaction and/or causes the (controlled) oxidation of polyphenols in the plant-based material. As used herein, the term “controlled” refers to the intentional act of causing decompartmentalization of polyphenols and/or oxidation of polyphenol. Thus, it is understood that, in contrast, unintentional or uncontrolled release of polyphenols is not considered part of the present disclosure as such unintentional or uncontrolled release would not be capable of tuning the colour change of the plant-based material to an animal-based product. That is, the natural oxidisation of a plant-based material is not part of a process/method as described herein as such natural oxidisation would not be considered a controlled process and, as shown in FIG. 13, the resulting unintentionally or uncontrolled oxidised material would not have the appearance of an animal-based product.

In some embodiments, the agent causes (controlled) loss of sub-cellular compartmentalisation of polyphenols and cellulose cell wall. The process of the present disclosure, however, is free of (or does not involve) complete (or substantially thorough) decellularization process such as processes that involve multiple changes of reagent to ensure thorough decellularization and/or removal of polyphenols. Methods that encompass complete or thorough decellularization of plant tissues with detergents is not within the purview of the present disclosure. Without wishing to be bound by theory, such methods of decellularizing plant tissues where little to no intracellular contents are left in the plant sample would not be considered to be part of the present disclosure because the resulting plant-based materials that are treated by such methods would have little to no intracellular contents and would typically be colourless. That is, the present disclosure does not include any process or treatment that remove any intracellular contents including the removal of polyphenols. In contrast to methods known in the art, the present disclosure discloses a process that causes incomplete decellularization and/or control permeabilization and/or oxidation over extended periods of time, which have been surprisingly found by the inventors of the present disclosure to provide colour change that would mimic the colour of an animal based product. The process of the present disclosure merely allows the release of polyphenol to allow for polyphenol-cell wall interaction to occur.

In some embodiments, the agent and/or the force capable of controlled permeabilization of cell membrane and/or oxidising polyphenols causes oxidation of phenols (such as polyphenols to o-quinones) and/or polymerisation to form coloured pigments (such as meat colour, brown colour, and the like). As such, the process of the present disclosure advantageously provides a colour alteration method that is not water soluble and will not be washed off during further processing (such as washing, soaking, cooking (such as boiling, frying, pickling, and the like), freeze-drying, brining, grinding (such as into pigment powder), preserving, and the like). In contrast to methods known in the art, as the process/method as disclosed herein provides colouration that cannot be washed off during further processing, the process/method as described herein can advantageously include a washing step to remove (completely or to trace amounts) any agents and/or plant extracts before the processed plant-based material is consumed. This washing step advantageously removes any agents and/or plant-based extracts to a level safe for consumption and/or removes any agents and/or plant-based extracts that may impart undesirable taste and/or smell. In various embodiments, the process/method as disclosed herein may further comprise the step of washing the processed plant-based product such that any polyphenols that are not integrated into the plant-based materials can be removed to thereby remove any excess polyphenols that may impart undesirable taste or smell.

In some embodiments, the agent is a cell permeabilising agent and/or oxidising polyphenols, wherein the agent is selected from the group consisting of a detergent, a redox agent, an enzyme, and an extract of a plant-based material. In some embodiments, the agent is a cell permeabilising agent and/or oxidising polyphenols are selected from the group consisting of a detergent, a redox agent, an enzymes, and the like. In some examples, the agent may be a cell permeabilising agent such as detergents selected from the group consisting of SDS, Tween-80, Tween-20, Triton X-10, saponin, sodium deoxycholate, 3-cholamidopropyl dimethylammonio 1-propanesulfonate (CHAPS), and the like. In various embodiments, the agent may be an enzyme selected from the group consisting of trypsin, dispase, and/or combination thereof. In various embodiments, the agent may be selected from the group consisting of sodium hydroxide, sodium bicarbonate, hydrogen peroxide, and the like.

In various embodiments, the agent and/or force maintains the cellulosic structures of the plant-based materials. That is, the agent does not disrupt the cellulosic structures of the plant materials. In some embodiments, the force is homogenisation and/or mechanical and/or physical shearing. Without wishing to be bound by theory, it is believed that mechanical shearing causes the disruption of cell membranes that allow adsorption of polyphenols to plant cell walls via hydrogen bonding and hydrophobic interactions with cellulose and pectin. In the present disclosure, whilst the agents do not disrupt cellulosic structures, it is found that mechanical forces do disrupt cellulosic structures to retrieve plant extracts. Such plant extracts are found to be surprisingly capable of causing colour change in another piece of plant material. As such, in various embodiments, the plant-based extracts form one of the agents that can cause colour change in another piece of plant material. In various embodiments, the agent is an extract of a plant-based material (plant-based extract). In various embodiments, the process and/or method as described herein is free of synthetic chemical homogenisation. In some embodiments, the plant-based extract may be a supernatant of plant-based material that has been processed with mechanical and/or physical shearing or homogenisation (such as using mortar and pestle, food processor, and the like), thermal shock process (such as freeze-thaw), by applying high pressure, by applying electroporation, by osmotic shock, and the like. In various embodiments, the mechanically or physically processed plant-based material may be diluted in a medium and/or water (such as deionized water). In some embodiments, the plant-based extract comprises of a medium such as a phosphate buffered saline (PBS), deionized water, distilled water, brine, any other colourless aqueous buffer, and the like. In some embodiments, the plant-based extract comprises deionized water to plant-based weight material in a ratio of about 0.1 ml to 10 ml of deionised to 0.1 g to 10 g wet plant-based, or 1 ml of deionized water for 1 g of wet plant-based material weight. In some examples, the plant-based extract may be used to treat the plant-based material in an undiluted or diluted form. Thus, the plant-based extract may be used to treat the plant-based material in a 1:1 to 100 dilution, or in a 1:2, or a 1:3, or a 1:4, or a 1:5, or a 1:10, or a 1:20, or a 1:50, or a 1:100 dilution in a medium (such as deionized water, PBS, or brine). Thus, in some examples, the plant-based extract comprises 1 g plant-based material weight in 1 ml deionized water or PBS. In various embodiments, the plant-based extract may be further diluted in the medium (such as deionized water, brine, or PBS) from 1× to 100× dilution, or about 2× dilution, or about 5× dilution, or about 10× dilution, or about 20× dilution, or about 30× dilution, or about 40× dilution, or about 50× dilution, or about 60× dilution, or about 70× dilution, or about 80× dilution, or about 90× dilution or about 100× dilution.

In some embodiments, the plant-based material comprises polyphenols and/or polyphenol oxidases.

In some embodiments, the plant-based material comprises polyphenols about 10 mg GAE (gallic acid equivalence) per 100 g dry weight of polyphenol or more, or 20 mg GAE per 100 g dry weight or more, or 30 mg GAE per 100 g dry weight or more, or 40 mg GAE per 100 g dry weight or more, or 50 mg GAE per 100 g dry weight or more, or 60 mg GAE per 100 g dry weight or more, or 70 mg GAE per 100 g dry weight or more, or 80 mg GAE per 100 g dry weight or more, or 90 mg GAE per 100 g dry weight or more, and the like. Without wishing to be bound by theory, it is envisaged that the more polyphenols a plant-extract comprises, the darker the processed or final plant-based material would be. The polyphenol concentration of a plant-based material can be determined by methods known in the art. For example, polyphenol concentration can be determined by the gallic acid equivalence (GAE) method using Folin-Ciocalteu reagent and expressed as gallic acid equivalents per unit dry weight of plant material. In brief, the method may comprise the step of having the plant based material to be freeze dried and polyphenols extracted by methanolic extraction; the extracts are then mixed with Folin-Ciocalteu reagent and absorbance compared to gallic acid of known concentration.

The plant-based materials that would be suitable for the present disclosure includes plants that comprise polyphenols and/or plants that are capable of permanently binding polyphenols to plant cell walls, thereby conferring permanent colour change to mimic animal-based material (such as meat). Suitable plant-based materials may be selected with the assistance of any energy and nutrient composition food database such as Health Promotion Board Energy and Nutrient Composition of Food Database. In some embodiments, the plant-based material is selected from the group consisting of apricots, avocados, banana, belimbi, binjai, cherries, Chinese pear, ciku, cucumber, custard apple, date, dragon fruit, duku, figs, golden kiwi, grape, grapefruit, guava, hog plum, honey dew, jackfruit, kiwifruit, kuini, langsat, lemons, lime, longan, loquat, lychee, mandarin orange, mango, mangosteen, mata kuching, mulberry, nectarine, nutmeg, orange, papaya, passion fruit, peach, pear, persimmon, pineapple, plum, pomegranate, pomelo, pulasan, quince, rambai, rambutan, raspberry, raspberry, rhubarb, rock melon, salak, soursop, starfruit, strawberry, tamarillo, tamarind, tomato, water apple, watermelon, wax jambu, aloe vera, asparagus, baby corn, banana flower, bean sprouts, broccoli, brussels sprouts, carrot, cauliflower, celery, champignon, chilli, choko, cucumber, drumstick vegetable, eggplant, fungus, gourd, Jew's ear, leek, lily bud, loofah, mushroom, okra, olive, papaya shoots, pea shoot, peppers, pumpkin, sea moss, seaweed, soybean sprouts, sweetcorn, tomato, white fungus, zucchini, bamboo shoots, beetroot, breadfruit, carrot, corn, garlic, ginger, huai shan, lengkuas, lotus root, onion, potato, radish, sweet potato, tapioca, taro, turnip, water chestnut, yam, white cabbage, chrysanthemum, endives, leek, lettuce, mustard cabbage, nai bai, sweet potato shoots, tapioca shoots, wintermelon, yam stalk, beans, chickpeas, long beans, peas, petai, and snow peas.

Several plant materials have been coloured using this method and the inventors have identified jackfruit (Artocarpus heterophyllusas) as providing a sample to demonstrate the method as described herein. Jackfruit is commonly grown in South East Asia and has established itself as a meat substitute owing to its stringy texture that mimics muscle fibres. It has been used in curries in Indian and South East Asian cooking as a mutton substitute. While the stringy consistency of jackfruits has been exploited in vegan cooking, there has been no attempts to control the colour of jackfruits to mimic the colour of meat apart from the use of sauces during cooking. As clearly illustrated in the Examples section, the present disclosure has shown the usefulness of jackfruit to create a plant-based meat substitute with meat-like colouration. Thus, in some examples, the plant-based material is a jackfruit fruit.

In some examples, the plant-based material may also be selected based on its translucency and/or fibre content. For example, translucency may be useful in providing the appearance of fat/adipose layer; fibre and/or sclerenchyma content may be useful in providing texture and/or appearance of tendon and/or marbling.

In some embodiments, the plant-based material comprises minimal to no chlorophyll. Without wishing to be bound by theory, a plant-based material that comprises chlorophyll may not be suitable for the method of the present disclosure as the green colour of chlorophyll would mask the colour change conferred by polyphenol and PPO (such as polyphenol-cell wall interaction). In various embodiments, the plant-based material may comprise at most (or a maximum) about 0.1 mg chlorophyll per g fresh weight of plant material, or about 0.1 to 0 mg chlorophyll per g fresh weight of plant material. Thus, in various embodiments, the plant-based material may comprise about 0.1 mg chlorophyll per g fresh weight of plant material or less.

The inventors of the present disclosure has studied the mechanism of colour changes in natural plant materials and found the surprising utility of developing permanent control of colour to match animal-based product (such as meat) without the addition of food colouring. Thus, in some embodiments, the process of the present disclosure is free of additives such as colouring agents or additives of polyphenols. It is contemplated that processes that include the addition of colouring agents and/or additives of polyphenols is not considered part of the present disclosure as such processes would not render colouration permanent and colours can be disadvantageously removed by washing or cooking with water and/or oil, leading to discolouration.

The duration of time a plant-based material is treated with the agent and/or force would vary depending on the agent and/or force used. However, without wishing to be bound by theory, the inventors of the present disclosure found that an extended duration of time a plant-based material is treated with the agent is useful. For example, in various embodiments, wherein the agent used is an agent that only causes permeabilization (such as SDS), the plant-based material is to be treated with the agent for 1 day or more. In various embodiments, wherein the agent causes both permeabilization and oxidation (such as sodium hydroxide or sodium bicarbonate), the plant-based material may be treated with the agent for about 10 mins to about 10 days. In some embodiments, the plant-based material is treated with the agent for about 10 mins to about 10 days, optionally the plant-based material is treated with the agent for 10 mins or more, or 20 mins or more, or 30 mins or more, or 40 mins or more, or 50 mins or more, 1 hour or more, or 2 hours or more, or 3 hours or more, or 4 hours or more, or 5 hours or more, or 6 hours or more, or 7 hours or more, or 8 hours or more, or 9 hours or more, or 10 hours or more, or 11 hours or more, or 12 hours or more, or 13 hours or more, or 14 hours or more, or 15 hours or more, or 16 hours or more, or 17 hours or more, or 18 hours or more, or 19 hours or more, or 20 hours or more, or 21 hours or more, or 22 hours or more, or 23 hours or more, or one day or more, or two days or more, or three days or more, or 4 days or more, or 5 days or more, or 6 days or more, or 7 days or more, or 8 days or more, or 9 days or more, or 10 days. In some embodiments, the plant-based material is treated with force for about 1 minute (min) to about 10 days, optionally the plant-based material is treated with the force for 1 mins or more, or 5 mins or more, or 10 mins or more, or 20 mins or more, or 30 mins or more, or 40 mins or more, or 50 mins or more, or 1 hour or more, or 2 hours or more, or 3 hours or more, or 4 hours or more, or 5 hours or more, or 6 hours or more, or 7 hours or more, or 8 hours or more, or 9 hours or more, or 10 hours or more, or 11 hours or more, or 12 hours or more, or 13 hours or more, or 14 hours or more, or 15 hours or more, or 16 hours or more, or 17 hours or more, or 18 hours or more, or 19 hours or more, or 20 hours or more, or 21 hours or more, or 22 hours or more, or 23 hours or more, or one day or more, or two days or more, or three days or more, or 4 days or more, or 5 days or more, or 6 days or more, or 7 days or more, or 8 days or more, or 9 days or more, or 10 days.

In addition to the presence of sclerenchyma tissue within parenchyma tissue of a plant-based material, the differential treatment of parts of the plant-based material could create meat marble-like patterns depending on the darkening effect of the agent on the plant-based material. Thus, in some embodiments, a part of the plant-based material is treated with the agent at differential concentration and/or time. For example, one part of the plant-based material may be treated with 1 × agent (such as a plant extract as described herein) and/or treated (incubated) with the agent (or plant extract) for 5 days, and another part of the plant-based material may be treated with 4× agent (such as a plant extract as described herein) and/or treated (incubated) with the agent (or plant extract) for 2 days. At the same time, meat marble-like patterns may be created due to the presence of sclerenchyma tissue that cannot be coloured by the process/methods as described herein. As such, in various embodiments, meat marble-like patterns may be provided by processing a plant-based material that comprises both sclerenchyma tissue and parenchyma tissue, wherein the sclerenchyma tissue may act as the plant vein and is not coloured by the process/method as described herein and the parenchyma tissue may act as the plant flesh and is coloured to mimic the colour of the desired animal-based product. Therefore, in some examples, the present disclosure provides for a process of modifying appearance of plant materials with both sclerenchyma and parenchyma tissues by releasing polyphenols from cells of plant materials using cell permeabilising agents or physical homogenisation and incubating for at least 30 mins without the addition of colouring agents.

In various embodiments, the process/method as described herein may further comprise the step of washing the plant-based material free of the agent. For example, the process/method as described herein may further comprise the step of washing the plant-based material with a medium (such as deionized water) such that the level of the agent is within a residual/trace level acceptable for (human) consumption based on the prevailing local food regulatory authority. In various embodiments, the washing may be performed for 1 hour to about 5 days, or 1 hour or more, or 2 hours or more, or 3 hours or more, or 4 hours or more, or 5 hours or more, or 6 hours or more, or 7 hours or more, or 8 hours or more, or 9 hours or more, or 10 hours or more, or 11 hours or more, or 12 hours or more, or 13 hours or more, or 14 hours or more, or 15 hours or more, or 16 hours or more, or 18 hours or more, or 19 hours or more, or 20 hours or more, or 21 hours or more, or 22 hours or more, or 23 hours or more, or 1 day or more, or 2 days or more, or 3 days or more, or 4 days or more, or up to 5 days.

In some examples, where the agent is a plant-based extract, the plant-based material and the plant-based extract may be from the same material (i.e. same plant) and/or from a different material (i.e. different parts of the same plant or different plants altogether). For example, in some examples, the plant-based material may be a jackfruit fruit and the plant-based material may be a jackfruit fruit extract. In some examples, the plant-based material may be a starfruit, a persimmon, or a water chestnut and the plant-based extract may be a jackfruit fruit extract.

Without wishing to be bound by theory, the process and/or products as described herein provides meat mimicry to produce meat substitutes.

In another aspect, there is provided a plant-based product comprising: a composition comprising a plant-based material processed according to the process as described herein.

As illustrated in the Examples section, the present disclosure has shown the process of the present disclosure can be utilised to mimic appearance of various types of animal-based products. For example, Example 1 shows the process of constructing a pork belly from plant-based materials (such as jackfruit and water chestnut or persimmon); Example 2 shows the process of mimicking the appearance of animal-based products such as chicken, pork, and beef.

The different plant-based materials in a plant-based product may be used to construct differing parts of an animal product. For example, different plant-based materials may be used to compose a pork-belly construct (i.e. a layer of meat and a layer of fat). In various embodiments, the plant-based materials may comprise a jackfruit with a persimmon and/or water chestnut treated with the method as described herein. Thus, in some embodiments, the plant-based product further comprising one or more different plant-based material.

In various embodiments, the resulting plant-based material comprises a plant-based material having permanent animal-based material-like colour. In various embodiments, the resulting plant-based material may further comprise trace amounts of the agents as described herein. In various embodiments, the resulting plant-based material may further comprise trace amounts of the cell permeabilizing agent and/or plant extracts. As used herein, the phrase “trace amounts” refer to an amount that is considered to be safe level for consumption (based on local food regulatory authority) and does not impart undesirable taste and/or smell.

In some examples, there is provided a plant-based chicken meat comprising a composition comprising a jackfruit flesh treated with a 1:20 diluted jackfruit extract (5% jackfruit extract) for 5 days.

In some examples, there is provided a plant-based pork meat comprising a composition comprising a jackfruit flesh treated with a 1:10 jackfruit extract (10% jackfruit extract) for 5 days.

In some examples, there is provided a plant-based beef meat comprising a composition comprising a jackfruit flesh treated with a (non-diluted) jackfruit extracts (100% jackfruit extract) for 5 days.

In some examples, there is provided a plant-based product comprising a composition comprising a persimmon fruit flesh treated with jackfruit extracts. In various examples, the persimmon fruit flesh is treated with undiluted or 100% concentration jackfruit fruit extracts.

In some examples, there is provided a plant-based product comprising a composition comprising a star fruit flesh treated with jackfruit extracts. In various examples, the persimmon fruit flesh is treated with undiluted or 100% concentration jackfruit fruit extracts.

In some examples, the plant-based product may include, but is not limited to, a food item, a decorative artifact, an artifact for use, and the like.

In some examples, the plant-based extract of the present disclosure may be used to colour plant-based meat substitutes and/or cell-based meat cuts (or minced meats) to thereby render the cell-based meats the appearance of a meat obtained from an animal. In various embodiments, plant-based extract does not require thorough washing to remove any agents. In contrast, in various embodiments, where the agent is a non-natural agent, such as synthetic chemical agents, a thorough washing step is necessary to remove the agents to reach a residual/trace safe amount for consumption (based on prevailing/local food regulatory authority).

In various embodiments, the present disclosure also provides a plant-based scaffold portion of an animal-based product (such as meat). In various embodiments, the coloured plant-based material using the process/method as described herein can be used directly or further processed to act as a scaffold for cell-based meat culture.

Additionally, when describing some embodiments, the disclosure may have disclosed a method and/or process as a particular sequence of steps. However, unless otherwise required, it will be appreciated the method or process should not be limited to the particular sequence of steps disclosed. Other sequences of steps may be possible. The particular order of the steps disclosed herein should not be construed as undue limitations. Unless otherwise required, a method and/or process disclosed herein should not be limited to the steps being carried out in the order written. The sequence of steps may be varied and still remain within the scope of the disclosure.

Further, in the description herein, the word “substantially” whenever used is understood to include, but not restricted to, “entirely” or “completely” and the like. In addition, terms such as “comprising”, “comprise”, and the like whenever used, are intended to be non-restricting descriptive language in that they broadly include elements/components recited after such terms, in addition to other components not explicitly recited. For an example, when “comprising” is used, reference to a “one” feature is also intended to be a reference to “at least one” of that feature. Terms such as “consisting”, “consist”, and the like, may, in the appropriate context, be considered as a subset of terms such as “comprising”, “comprise”, and the like. Therefore, in embodiments disclosed herein using the terms such as “comprising”, “comprise”, and the like, it will be appreciated that these embodiments provide teaching for corresponding embodiments using terms such as “consisting”, “consist”, and the like. Further, terms such as “about”, “approximately” and the like whenever used, typically means a reasonable variation, for example a variation of +/−5% of the disclosed value, or a variance of 4% of the disclosed value, or a variance of 3% of the disclosed value, a variance of 2% of the disclosed value or a variance of 1% of the disclosed value.

Furthermore, in the description herein, certain values may be disclosed in a range. The values showing the end points of a range are intended to illustrate a preferred range. Whenever a range has been described, it is intended that the range covers and teaches all possible sub-ranges as well as individual numerical values within that range. That is, the end points of a range should not be interpreted as inflexible limitations. For example, a description of a range of 1% to 5% is intended to have specifically disclosed sub-ranges 1% to 2%, 1% to 3%, 1% to 4%, 2% to 3% etc., as well as individually, values within that range such as 1%, 2%, 3%, 4% and 5%. The intention of the above specific disclosure is applicable to any depth/breadth of a range.

It will be appreciated by a person skilled in the art that other variations and/or modifications may be made to the specific embodiments without departing from the scope of the invention as broadly described. For example, in the description herein, features of different exemplary embodiments may be mixed, combined, interchanged, incorporated, adopted, modified, included etc. or the like across different exemplary embodiments. The present embodiments are, therefore, to be considered in all respects to be illustrative and not restrictive.

### EXAMPLES

### Materials and Methods

### Preparation of Plant Extracts

All fresh plant samples were obtained from a local market in Woodlands, Singapore. Green jackfruits in brine were obtained from Nature's Charm (Singapore). Plant samples were cut into approximately 1 cm³ cubes, washed in deionized water and dabbed dry with a paper towel. The plant samples were ground finely with mortar and pestle and mixed with phosphate buffered saline (PBS) at a ratio of 1 mL deionized water for 1 g of wet plant weight. Samples were mixed thoroughly for 5 mins and centrifuged. Supernatants were used as plant extracts (100%). Plant extracts were diluted to lower concentrations to create different shades of colours.

### Colour Control of Plant Materials

Plant samples were cut into 2 mm thick disks of 6 mm diameter using a biopsy punch, washed in deionized water and dabbed dry with a paper towel. The plant samples were incubated in various reagents and plant extracts. Care was taken to ensure plant samples were always fully immersed in reagents. Samples were imaged with a Canon EOS 1000D DSLR camera and 60 mm f/2.8 macro lens at specified time points and colour corrected with an X-Rite ColorChecker Nano. Images were cropped and processed with ImageJ to obtain the L*, a* and b* values for colour quantification. Colour change ΔE* was calculated using the formula for colour difference in 1976 CIELAB space (Schwiegerling, 2004):

ΔE_{ab}*={square root over ((L₂−*L₁*)²+(a₂−*a₁*)²+(b₂−*b₁*)²))}.

### Removal of polyphenols with PVP

Jackfruit samples were ground finely with mortar and pestle and washed with 1% (w/v) polyvinylpyrrolidone (PVP) to remove plant polyphenols. Control samples were prepared by washing with deionized water in place of PVP. Samples were left to stand in PBS and their colour changes tracked over time.

### Colour Stability of Jackfruits

Jackfruits were treated with 20% SDS for 5 days to develop a red colouration. The jackfruit samples were then stored in PBS with pH adjusted using sodium hydroxide or hydrochloric acid to obtain desired pH. Jackfruits were also stored in sunflower oil. Images were taken every 4 days with the DSLR camera and colours quantified as described above.

### High-Resolution Imaging of Prototype

High-resolution image of meat mimicry prototype was obtained with a TissueFAXS Slide Scanner. The set-up was modified by applying white light using a light source directed at the sample from below to achieve a stereomicroscope-like set-up. White balance was corrected using the X-Rite ColorChecker Nano.

### Preparation of Meat Samples

Chicken, pork, and beef samples were purchased from a local supermarket in Kent Ridge, Singapore. Samples were either cut with scalpels and biopsy punches or moulded into 2 mm thick disks of 6 mm diameter prior to imaging.

### Results

### De-Compartmentalization is Essential for Colour Control

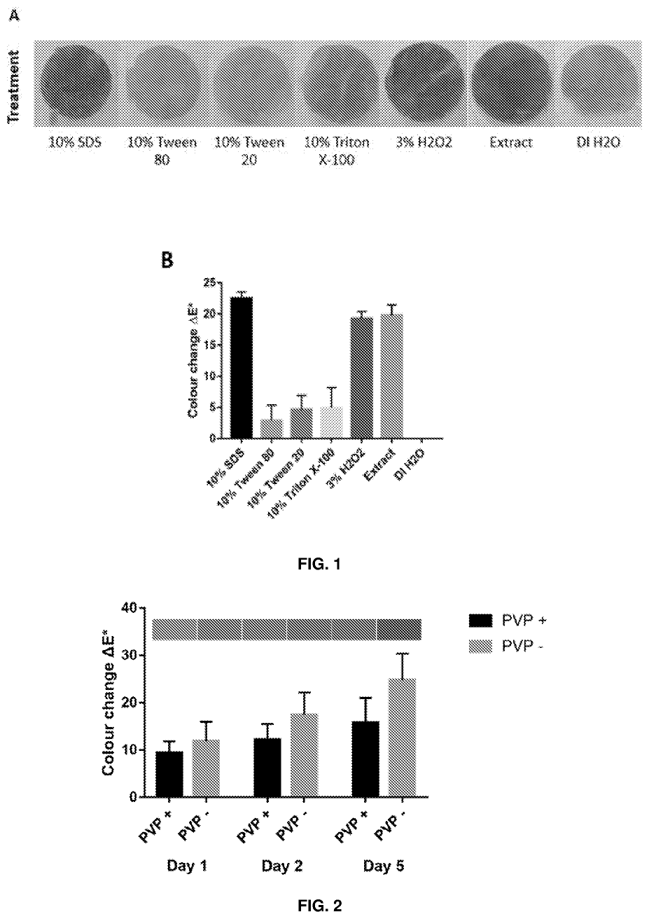

Meat-like colouration was observed to have developed after 5 days with treatment of jackfruit with various detergents known to permeabilize cells (FIG. 1). A greater colour change was observed when stronger detergents such as sodium dodecyl sulfate (SDS) was used compared to weaker detergents like Tween-80, Tween-20 and Trion X-100. Hydrogen peroxide, a common redox reagent known to disrupt cell membranes, produced the same colour changes. Treatment with jackfruit extracts prepared by physical homogenization to release intracellular contents also produced the same effect. These results indicate that disruption of plant cell compartmentalization is essential for colour control.

### Polyphenols are Essential for Colour Control

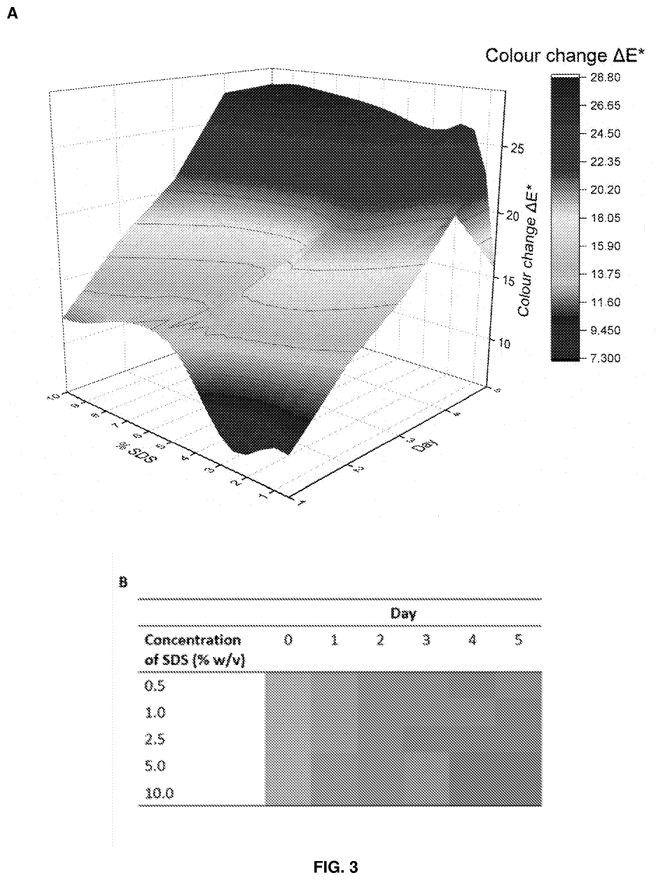

The role of polyphenols in generation of meat-like colours is investigated in jackfruits in this study as polyphenols are known to contribute significantly to plant colour. Plant polyphenols were removed by washing with polyvinylpyrrolidone (PVP), a polymer known to be effective at absorbing polyphenols. It was observed that colour change was impeded when jackfruits were washed with PVP compared to the control sample (FIG. 2), indicating a role for polyphenols in directing colour change.

### Precise Control of Colour Change

Next, the present disclosure seeks to utilize the method as disclosed herein to precisely control the colour of jackfruit to mimic meat. Jackfruits were treated with different concentrations of SDS and their colours tracked over time. Colour change was intensified with higher concentrations of SDS and longer incubation times (FIG. 3). As was hypothesized, treating jackfruits with SDS indeed released polyphenols into the media for the colour change reaction to occur. Increasing SDS concentrations and incubation times allow more polyphenols to be released and thus intensifying the colours. Meat-like colouration was found to not have developed immediately but required extended incubation times.

### Colour is Stabilized with pH Control

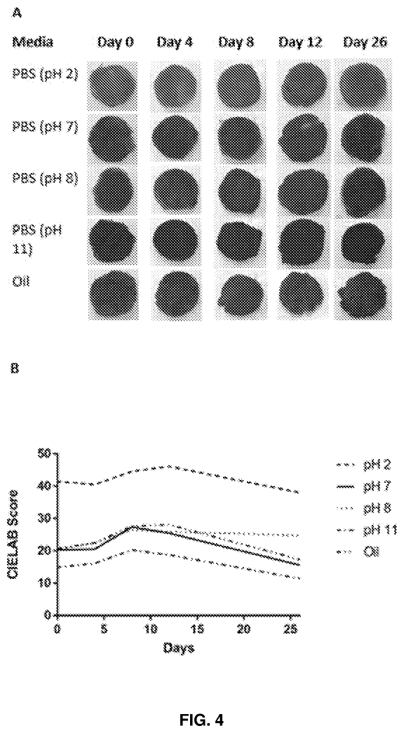

To be utilized as a robust food colouring technique, colours need to be stable during storage. FIG. 4 demonstrates the colour stability of processed jackfruits over time. The present inventors found that a colouring technique involving polyphenols, the colours of processed jackfruits were pH sensitive. Storage under acidic conditions produced a lighter colour, while storage under alkaline conditions produced a darker colour (FIG. 4A). Storage under neutral pH and in oil retained original colours. Colours were also neither water-soluble nor oil soluble. Storage under aqueous conditions of pH 8 had the least colour changes (FIG. 4B). Overall, minimal colour change was observed over time, indicating the suitability of this technique for controlling colours of plant materials.

### Colours do not Leach when Cooked in Water or Oil

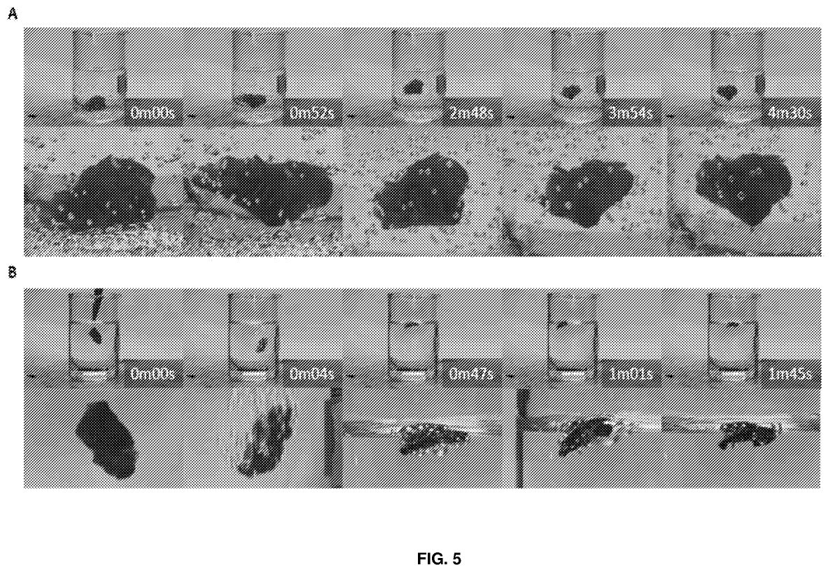

A clear advantage of this colouring technique compared to the use of colour additives is the lack of colour leaching during wet storage and cooking. The present inventors demonstrated this advantage by boiling processed jackfruits in tap water and frying processed jackfruits in sunflower oil to simulate cooking. It was observed that under these treatments, the red colours do not leach out (FIG. 5), indicating utility of this technique for permanent colouration of foods.

### Example 1: Generation of Patterned Meat Mimicry Using Different Plant Materials

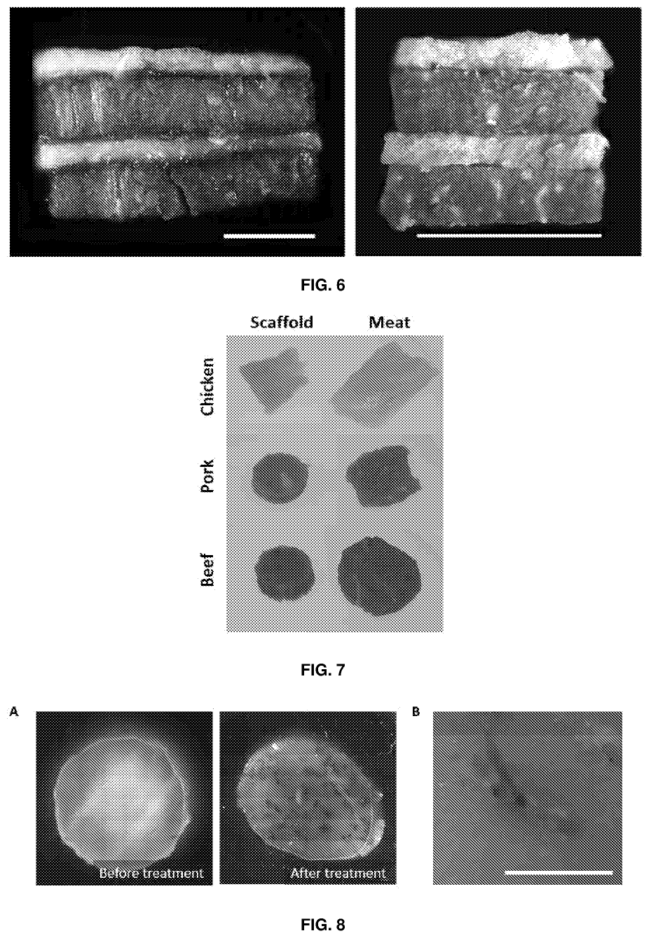

The present inventors exploited the ability of this technique to colour different plant materials to different extents to create patterned meat mimicry. Plant-materials can be prearranged into desired patterns and colour change induced by addition of reagents or plant extracts. In this study, a pork belly-like construct was created by layering jackfruits with water chestnut and inducing colour changes with jackfruit extracts to create the pattern. Differential colour changes were observed over time which creates the pattern (FIG. 6). Jackfruits, which were originally pale yellow, developed a red colouration overtime. Parts of the jackfruits remained white, simulating intramuscular fat. Water chestnut has white and translucent appearance to simulate intermuscular.

### Example 2: Colour Control of Jackfruits to Mimic Various Meats

The present inventors further demonstrate the utility of this colour control technique to mimic different types of meat. Samples of chicken, pork and beef were prepared, and its colour compared to that of processed jackfruits. Jackfruits treated with 5% jackfruit extracts for 5 days were used to mimic chicken (FIG. 7A). Jackfruits treated with 10% jackfruit extracts for 5 days were used to mimic pork (FIG. 7B). Jackfruits treated with 100% jackfruit extracts for 5 days were used to mimic beef (FIG. 7C). When compared with the three types of meats, processed jackfruits had the lowest colour difference with pork. This demonstrates the utility of this colour control technique for mimicking different types of meats.

### Example 3: Colour Control of Persimmon

Utility of this colour control technique can be expanded to include other plants. Here the present inventors demonstrate the utility of using jackfruit extracts to control the colour and patterns of persimmon. After treatment with jackfruit extracts for 5 days, persimmon fruit flesh developed brown-coloured lined patterns (FIG. 8). Such patterns can have applications in controlling the appearance of plant-based foods and ornaments.

### Example 4: Colour Control of Starfruit

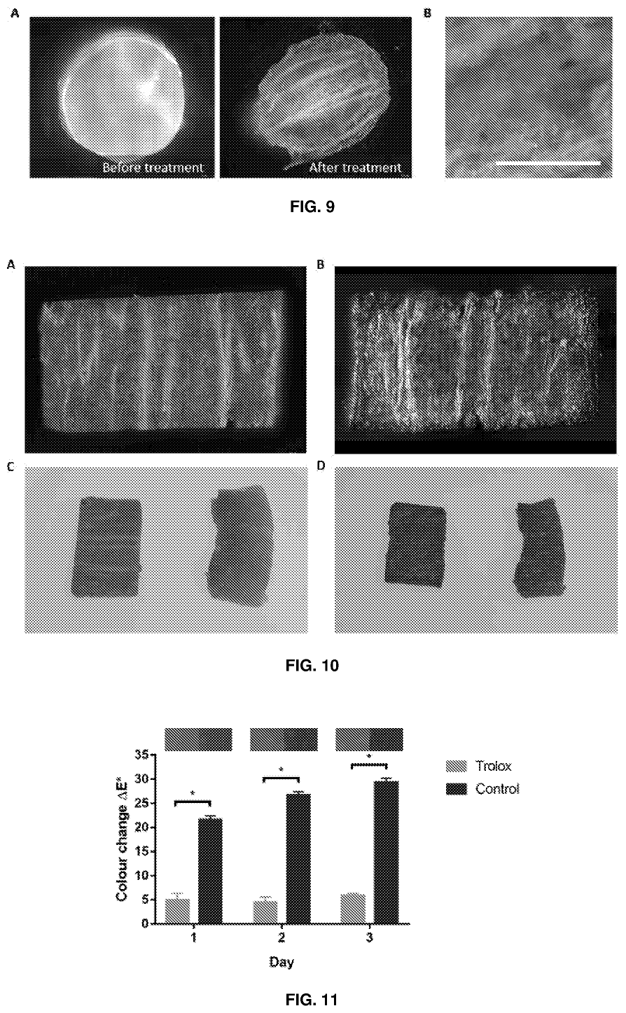

Utility of this colour control technique can be expanded to include other plants. Here the present inventors demonstrate the utility of using jackfruit extracts to control the colour and patterns of star fruit. After treatment with jackfruit extracts for 5 days, starfruit fruit flesh developed reddish-brown-coloured lined patterns (FIG. 9), similar to that in persimmon (FIG. 8). Such patterns can have applications in controlling the appearance of plant-based foods and ornaments.

### Example 5: Differential Colour Control in Single Piece of Jackfruit to Mimic Meat Marbling

The present inventors demonstrate the utility of this colour control technique to differentially colour a single piece of jackfruit to create intricate patterns to mimic marbling in meats. This technique works by leveraging on natural organization of the parenchyma and the sclerenchyma in plants and colouring the two parts differently based on their composition to create intricate patterns. Jackfruit samples were differentially coloured red and white to create a marbling effect (FIG. 10A). Frying this marbled jackfruit creates meat-like char and the white “fatty” portions turn translucent like animal fat (FIG. 10B). Comparison of appearance with a piece of cured pork was performed (FIG. 10C-D). This demonstrates the utility of this colour control technique for creating marbled plant-based meat cuts.

### Example 6: Quantified Colour Change of Jackfruits over Time Using Synthetic Chemical

Quantified colour change was analysed on jackfruits treated with 10% SDS (control) or 10% SDS with 10 mM Trolox (Trolox+) (see FIG. 11). Asterisk indicate significant differences based on Student's t-test. * means p<0.00003. n=3. The data shows that oxidation is a possible factor in the mechanism for colour change, as addition of an antioxidant (Trolox) prevented colour change.

Jackfruit samples were treated with an aqueous solution of 10% (w/v) SDS and 10 mM Trolox (Merck, Singapore). A control sample was prepared and treated with 10% (w/v) SDS only. Colour changes were tracked and quantified as described previously.

### Example 7: Time-Lapse Imaging of Development of Marbling Patterns in Jackfruit

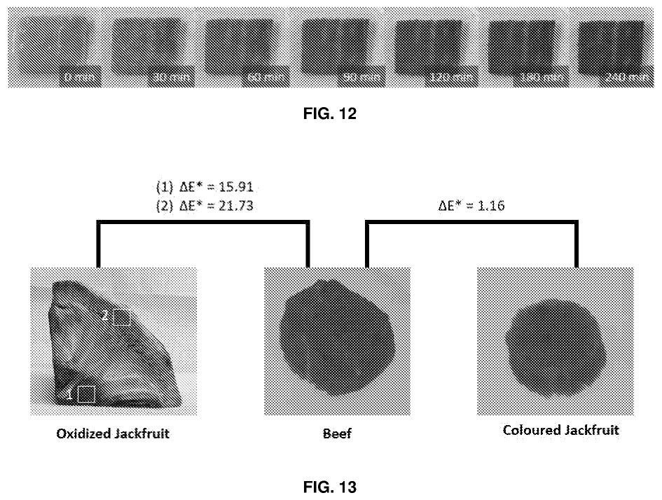

Time-lapse imaging of development of marbling patterns in jackfruit (see FIG. 12). Red and white patterns developed from the original homogenous colour. A drop of 1% (w/v) sodium bicarbonate was placed on a piece of jackfruit and colour change tracked every 30 mins with a DSLR camera.

### Example 8: Comparison of Colour between Coloured and Naturally Oxidized Jackfruit

Comparison of colour between coloured and naturally oxidized jackfruit (see FIG. 13). Quantification of colour change in the CIELAB space showed a much greater colour difference between oxidized jackfruit and beef (>15), than between beef and coloured jackfruit (˜1). Images were taken, processed and quantified as described previously. The data shows that the colour change is not caused by simple enzymatic browning but involves decompartmentalization due to physical and chemical agents.

### REFERENCES

1. Ajami, D., Anderson, D., Dill, J., Geistlinger, T., Mayoral, K., Ba Ngo, H., Noreiga, T., Suarez-Trujillo, D., Timmons, M., Walton, T., Ryan, D. A. (2019). Meat-like food products. US20190037893A1.

2. Askew, K. (2018, Nov. 2). From jackfruit to acqafaba and miso: Waitrose identifies trailblazing food trends. Retrieved Nov. 3, 2019, from https://www.foodnavigator.com/Article/2018/11/02/From-jackfruit-to-acqafaba-and-miso-Waitrose-identifies-trailblazing-food-trends.

3. Datar, I., & Betti, M. (2010). Possibilities for an in vitro meat production system. Innovative Food Science and Emerging Technologies, 11(1), 13-22. doi:10.1016/j.ifset.2009.10.007

4. Elzerman, J. E., Hoek, A. C., Boekel, M. A. V., & Luning, P. A. (2011). Consumer acceptance and appropriateness of meat substitutes in a meal context. Food Quality and Preference, 22(3), 233-240. doi: 10.1016/j.foodqual.2010.10.006

5. Fellet, M. (2015). A Fresh Take on Fake Meat. ACS Central Science, 1(7), 347-349. doi: 10.1021/acscentsci.5b00307

6. Fraser, R. Z., Shitut, M., Agrawal, P., Mendes, O., & Klapholz, S. (2017). Safety evaluation of soy leghemoglobin protein preparation derived from Pichia pastoris, intended for use as a flavor catalyst in plant-based meat. International Journal of Toxicology. doi: 10.1101/196766

7. Godfray, H. C. J., Springmann, M., Sexton, A., Lynch, J., Hepburn, C., & Jebb, S. (2019). Meat: The Future Series—Alternative Proteins. Retrieved from http://www3.weforum.org/docs/WEF_White_Paper_Alternative_Proteins.pdf

8. John, P. J., Sarvamangala, G. K., Narasimham, P. (1992). Textural and sensory attributes of curried raw jack fruit, fried and pressure cooked. Journal of Food Quality. Doi: 10.1111/j.1745-4557.1992.tb00993.x

9. Renard, C., Watrelot, A., Le Bourvellec, C. (2017). Interactions between polyphenols and polysaccharides: Mechanisms and consequences in food processing and digestion. Trends in Food Science and Technology, 60, pp. 43-51. 10.1016/j.tifs.2016.10.022.hal-01506642f

10. Schwiegerling, J. (2004) Field Guide to Visual and Ophthalmic Optics, SPIE Press, Bellingham, Wash.

11. Sexton, A. E., Garnett, T., & Lorimer, J. (2019). Framing the future of food: The contested promises of alternative proteins. Environment and Planning E: Nature and Space, 2(1), 47-72. doi:10.1177/2514848619827009

12. Shoji, T. (2007). Polyphenols as Natural Food Pigments: Changes During Food Processing. American Journal of Food Technology, 2: 570-581.

13. Taranto, F., Pasqualone, A., Mangini, G., Tripodi, P., Miazzi, M. M., Pavan, S., Montemurro, C. (2017). Polyphenol Oxidases in Crops: Biochemical, Physiological and Genetic Aspects. Int. J. Mol. Sci., 18, 377.

14. Vrljic, M., Solomatin, S., Fraser, R., Brown, P. O., Karr, J., Holz-Schietinger, C., Eisen, M. (2014). Methods and compositions for consumables. WO2014110539A1.

15. Zhu, F. (2018) Interactions between cell wall polysaccharides and polyphenols, Critical Reviews in Food Science and Nutrition, 58:11, 1808-1831, DOI: 10.1080/10408398.2017.1287659

1. A process, comprising
treating a plant-based material with an agent and/or a force capable of permeabilising cell membrane and/or oxidising polyphenols, wherein the agent and/or force is capable of controlled permeabilization of cell membrane to thereby release polyphenols from the cells of the plant-based material to allow polyphenol-cell wall interaction and/or causes the oxidation of polyphenols in the plant-based material, and
wherein the plant-based material comprises minimal to no chlorophyll.

2. The process of claim 1, wherein the agent causes loss of sub-cellular compartmentalisation of polyphenols and cellulose cell wall.

3. The process of claim 1, wherein the agent and/or the force capable of controlled permeabilization of cell membrane and/or oxidising polyphenols causes oxidation of phenols to o-quinones and/or polymerisation to form coloured pigments.

4. The process of claim 1, wherein the agent is selected from the group consisting of a detergent, a redox agent, an enzyme, and an extract of a plant-based material.

5. The process of claim 1, wherein the agent and/or force maintains the cellulosic structures of the plant-based materials.

6. The process of claim 1, wherein the force is homogenisation and/or mechanical and physical shearing.

7. The process of claim 1, wherein the plant-based material comprises polyphenols and/or polyphenol oxidases.

8. The process of claim 1, wherein the plant-based material comprises polyphenols at least about 10 mg GAE (gallic acid equivalence) per 100 g dry weight of polyphenol.

9. The process of claim 1, wherein the plant-based material comprises a parenchyma tissue and/or a sclerenchyma tissue.

10. The process of claim 1, wherein the plant-based material is selected from the group consisting of apricots, avocados, banana, belimbi, binjai, cherries, Chinese pear, ciku, cucumber, custard apple, date, dragon fruit, duku, figs, golden kiwi, grape, grapefruit, guava, hog plum, honey dew, jackfruit, kiwifruit, kuini, langsat, lemons, lime, longan, loquat, lychee, mandarin orange, mango, mangosteen, mata kuching, mulberry, nectarine, nutmeg, orange, papaya, passion fruit, peach, pear, persimmon, pineapple, plum, pomegranate, pomelo, pulasan, quince, rambai, rambutan, raspberry, rhubarb, rock melon, salak, soursop, starfruit, strawberry, tamarillo, tamarind, tomato, water apple, watermelon, wax jambu, baby corn, banana flower, bean sprouts, carrot, cauliflower, celery, champignon, chili, choko, drumstick vegetable, eggplant, fungus, gourd, Jew's ear, leek, lily bud, loofah, mushroom, okra, olive, papaya shoots, pea shoot, peppers, pumpkin, sea moss, soybean sprouts, sweetcorn, white fungus, zucchini, bamboo shoots, beetroot, breadfruit, corn, garlic, ginger, huai shan, lengkuas, lotus root, onion, potato, radish, sweet potato, tapioca, taro, turnip, water chestnut, yam, white cabbage, chrysanthemum, endives, leek, sweet potato shoots, tapioca shoots, wintermelon, yam stalk, beans, chickpeas, long beans, peas, and snow peas.

11. (canceled)

12. The process of claim 1, wherein the process is free of colouring agents.

13. The process of claim 1, wherein the plant-based material is treated with the agent for about 10 minutes to about 10 days, optionally the plant-based material is treated with the agent for 10 minutes or more, 1 hour or more, one day or more, or two days or more, or three days or more, or 4 days or more, or 5 days or more, or 6 days or more, or 7 days or more, or 8 days or more, or 9 days or more, or 10 days.

14. The process of claim 1, wherein the plant-based material is treated with the force for about 1 minute to about 10 days.

15. The process of claim 1, wherein a part of the plant-based material is treated with the agent at differential concentration and/or time.

16. A plant-based product comprising:
a composition comprising a plant-based material processed according to the process of claim 1.

17. The plant-based product of claim 16, further comprising one or more different plant-based material.

18. The process of claim 1, wherein the plant-based material comprises 0.1 mg chlorophyll per g fresh weight of plant-based material or less.

19. A process, comprising
treating a plant-based material with an agent and/or a force capable of permeabilising cell membrane and/or oxidising polyphenols, wherein the agent and/or force is capable of controlled permeabilization of cell membrane to thereby release polyphenols from the cells of the plant-based material to allow polyphenol-cell wall interaction and/or causes the oxidation of polyphenols in the plant-based material, and
wherein the plant-based material is selected from the group consisting of aloe vera, broccoli, brussels sprouts, seaweed, lettuce, mustard cabbage, nai bai, petai, and asparagus.
